(19) United States
(12) Patent Application Publication
(10) Pub. No.: US 2013/0090993 A1
(43) Pub. Date: Apr. 11, 2013

(54) METHOD OF PROVIDING DISCOUNTED PRODUCTS AND SERVICES

(71) Applicants: Trish J. Taylor, Austin, TX (US); Gary H. Hickox, Rancho Mirage, CA (US)

(72) Inventors: Trish J. Taylor, Austin, TX (US); Gary H. Hickox, Rancho Mirage, CA (US)

(21) Appl. No.: 13/267,833

(22) Filed: Oct. 6, 2011

(51) Int. Cl. G06Q 30/02

(52) U.S. Cl. 705/14.1

(57) ABSTRACT

The present invention is a method for managing and providing discounts for fertility pharmaceutical medications and services. Specifically, the invention is method for providing discounts for medications and services by using a discount card that: (1) provides cash-paying patients with access to pharmaceutical and medical discounts; (2) provides pharmaceutical companies an opportunity to brand and market themselves; and (3) provides participating pharmacies a source of new and dedicated customers. The cost of the discount card, which is typically purchased by the customer directly, is reimbursed at equal cost to the customer through a gift card, which must be redeemed in a participating pharmacy or retail store. The card may be provided to the customer by doctors, fertility centers, pharmacies, self insured groups, insurers and retail stores, rather than being purchased directly.

### FIELD OF THE INVENTION

The invention relates, generally, to a method for providing consumers or customers with discounted products and services through the use of a discount card program. More specifically, the method provides discounts on fertility-based medications available from pharmacies. In particular, the invention is a method that efficiently manages discounts for medications and services by: (1) providing patients more access to fertility related pharmaceuticals through a discount; (2) providing pharmacies and pharmaceutical companies branding and marketing opportunities; and (3) providing participating pharmacies a source of new and dedicated customers.

### BACKGROUND OF THE INVENTION

Each year, thousands of couples discover that having a baby will be more difficult than they thought due to infertility. The medical and pharmaceutical industries have developed treatments and drugs in order to help those couples overcome infertility problems. Although many of these treatments and drugs are effective, they can be very expensive. Furthermore, the treatments and drugs might require months or even years to be effective. Accordingly, in order to have a baby, infertile couples must sometimes spend thousands or even tens of thousands of dollars over the course of several years.

Although infertility is typically a medical problem, the costs of treating the infertility are not covered by many health insurance plans or companies. As such, the high costs of fertility treatments and drugs are borne completely by the couple seeking the treatments or drugs. Although infertility insurance is available, for individuals or for insurance plans, this insurance is expensive and is not affordable for many couples.

Therefore, what is needed is a method or system of providing and managing significant discounts to patients on certain prescribed fertility-based medications and services without the need for insurance coverage, by providing a discount card, in which a patient receives discounts when purchasing prescribed drugs and medical services with the discount card.

### SUMMARY OF THE INVENTION

To minimize the limitations in the prior art, and to minimize other limitations that will become apparent upon reading and understanding the present specification, the present invention discloses a new and useful method for managing and providing discounts on fertility drugs.

One embodiment of the invention is a method of managing a computer-based discount program and providing discounts for goods/services, the steps comprising: providing a computer-based discount management program; providing a plurality of discount cards; obtaining the plurality of discount cards by a plurality of customers; activating the plurality of discount cards obtained by the plurality of customers; assigning each of the plurality of activated discount cards a unique identification number such that a plurality of unique identification numbers is created; registering the plurality of unique identification numbers within the computer-based discount management program, such that a plurality of registered discount cards are created; wherein the plurality of registered discount cards provide a plurality of discounts for a plurality of goods/services, such that a plurality of discounted goods/services are available; using the plurality of registered discount cards such that a plurality of customers receive one or more of the plurality of discounts when purchasing the plurality of goods/services. Preferably, the method includes the steps of: inputting a plurality of customer data into the computer-based discount management programs; wherein when the plurality of customer data is input into the computer-based discount management program, the computer-based discount management program automatically generates the plurality of identification numbers that are assigned to the plurality of discount cards; wherein the plurality of discount cards display one or more brands of a plurality of companies that provide the plurality of goods/services; wherein the plurality of discounted goods/services are comprised of a plurality of fertility medications; wherein the plurality of fertility medications are comprised of a plurality of prescription medications; wherein the plurality of discounted goods/services are purchased by the plurality of consumers or customers directly without insurance, with limited insurance (a person without insurance or with limited insurance is a person without adequate insurance); wherein at least one of the plurality of discount cards are purchased directly by at least one of the plurality of customers; wherein a cost of the at least one discount card purchased directly by the at least one customer is refunded via a gift card. Alternatively, the plurality of discount cards are purchased directly by the group consisting of: a obstetrician; a gynecologist; a fertility center; a pharmacy; a pharmaceutical company; a physician; a retail store; a self insured group; and an insurer. Preferably, the method includes the steps of: negotiating by an operator of the computer-based discount management program the plurality of discounts with the plurality of companies that provide the plurality of goods/services; wherein at least one of the plurality of discount cards are provided as part of an advertisement.

Another embodiment of the invention is a method of managing discounts for prescribed medications and services, the steps comprising: providing a discount card; wherein the discount card provides one or more discounts for one or more pharmaceutical products; purchasing the discount card by a patient; activating the discount card; assigning an identification number of the patient to the discount card; registering the identification number in a computer online system; and receiving the one or more discounts when purchasing one or more pharmaceutical products with the discount card. Preferably, when the discount card is purchased online, the identification number is automatically assigned at that time. then, an email with patient identification goes to the administrator of the system and the participating pharmacy. The participating pharmacy then fulfills the order and provides the agreed to discount. Preferably, the discount card includes one or more brands of the pharmaceutical companies. Preferably, the providing step of the discount card is performed by the group consisting of: a obstetrician; a gynecologist; a fertility center; a pharmacy; a pharmaceutical company; a physician; a retail store; a self insured group; and an insurer. The discount card is preferably purchased with a credit card online, or with a credit card or cash if purchased in pharmacy store or retail store. Generally, the purchasing step of the discount card by the patient is further comprised of the steps of: purchasing the discount card online; and receiving the discount once the order is purchased with the pharmacy over the phone or in pharmacy store; and receiving the medication by mail to the patient. Generally, the registering step is further comprised of steps of: inputting information of the patient in a computer online system; and sending an acknowledgment to the patient. The acknowledgment confirms a completion of the registering step. Typically, the one or more discounts are negotiated by a third party and all discounts are agreed prior to discount card being distributed to the general public. The discount card may include an advertisement document. The one or more pharmaceutical products can be one or more prescribed medications. The discount card medication package received by the patient includes a gift card of the same value redeemed at agreed in-store pharmacy or retail store.

Another embodiment of the present invention is a method of managing discounts for prescribed medications and services, the steps comprising: providing an advertisement document; wherein the advertisement document includes a discount card and wherein the discount card provides one or more discounts for one or more pharmaceutical products; purchasing the discount card with a credit card online or credit card or cash if purchased in pharmacy or retail store by a patient; activating the discount card; assigning an identification number of the patient to the discount card; registering the identification number in a computer online system; sending an acknowledgment to the patient; wherein the acknowledgment confirms a completion of the registering step; and receiving the one or more discounts when purchasing one or more pharmaceutical products with the discount card. Preferably, the discount card includes one or more brands of the pharmaceutical companies. Preferably, the providing step of the advertisement document with the discount card is performed by the group consisting of: a obstetrician; a gynecologist; a fertility center; a pharmacy; a pharmaceutical company; a physician; a retail store; a self insured group; and an insurer. Generally, the one or more discounts is negotiated by a third party and all discounts are agreed prior to discount card being distributed to the general public. The purchasing step of the discount card by the patient may further comprise of the steps of: purchasing the discount card online; and receiving the discount card by mail to the patient. Preferably, the discount card is received upfront in the marketing card, which was previously mailed to the consumer or retailer, and/or sent in an email received by the consumer after purchasing online. The consumer may receive the medications by mail or, in some cases, the consumer or patient will be able to pick up the prescribed and discounted medicine within the pharmacy as well. The discount card is preferably not directly mailed to the consumer. The gift card in the same amount as the cost of the discount card is preferably mailed to the consumer and, in some cases, the gift card may be handed to the consumer in the pharmacy or retail store. The one or more pharmaceutical products may be one or more prescribed medications. The discount card may be a gift card.

Another embodiment of the present invention is a method of managing discounts for prescribed fertility medications and services, the steps comprising: providing an advertisement document; wherein the advertisement document includes a discount card and wherein the advertisement document with the discount card is provided by the group consisting of: a obstetrician; a gynecologist; a fertility center; a pharmacy; a pharmaceutical company; a physician; a retail store; a self insured group; and an insurer; the discount card includes one or more brands of the pharmaceutical companies and provides one or more discounts of one or more pharmaceutical products; wherein the one or more discounts are negotiated by a third party and all discounts are preferably agreed to prior to discount card being distributed to the general public; purchasing online the discount card with a credit card by a patient; receiving the medication by mail to the patient; activating the discount card; wherein the discount card is activated from a group consisting of: a patient, a pharmacy; a doctor; and a retail store; assigning an identification number of the patient to the discount card; registering the identification number in a computer online system; sending an acknowledgment to the patient; wherein the acknowledgment confirms a completion of the registering step; and receiving the one or more discounts when purchasing one or more pharmaceutical products with the discount card; wherein the one or more pharmaceutical products are one or more prescribed medications.

The present invention allows the discount card to be a gift card, phone card, or debit card and may include an advertising document.

It is an object of the present invention to overcome the limitations of the prior art.

It is an object of the present invention to provide a method managing discounts for prescribed fertility medications and services.

It is another object of the present invention to provide a discount program that: a) provides more patient access to prescription medication discounts with immediate value being available in retail stores with in-pharmacy services and inside OBGYN offices and fertility centers; b) provides patients with immediate face-to-face consultation for their discounted medications when purchased in the pharmacy or store or fertility center; c) provides patient direct discounts on fertility medications where no other discounts are available to the patient directly outside of the fertility doctor; d) provides cash paying patients with no traditional insurance or limited to no prescription medication or limited to no fertility medication coverage a substantial discount on their medication needs; e) provides an avenue of branding for the pharmaceutical companies that participate on the card; f) provides an avenue of branding for the pharmacies that participate on the card; g) provides the opportunity for the pharmaceutical company and the pharmacy company to associate their brand's together for maximum market impact; and h) allows makers of retail products, i.e. pregnancy test kits, to offer their users substantial discounts on fertility medications by way of co-marketing features of present invention on the product packaging.

It is an object of the present invention to provide a method of providing discounts of fertility care drugs through a care card. The card may be sold by the program provider, a pharmacy, a fertility doctor or clinic, a retail store, an insurance agency, or a pharmaceutical company. The card may be bought at a physical location or online. Once purchased, the customer registers his or her information with the online discount program administrator. The card may then be used to purchase prescription fertility medicines. The pharmacy fulfilling the prescription, provides the promised medication discounts and processes the patients' payment for the prescription over the phone or in the pharmacy. The prescription is picked up at the in-store pharmacy or the pharmacy mails the medication direct to the patient. Preferably, there is a special identification between the particular pharmaceutical drug company and the pharmacy in order to track sales and identify each medication discount. If the customer buys the card, he or she preferably receives a gift card for the amount paid to enroll in the discount program and receive the discount card. The gift card is preferably redeemable at the store/pharmacy where the discount card was sold.

Other features of the present invention include online payment directly on a website with all fulfillment process on the same website. If the pharmacy sells the discount card, the pharmacy would have access to track the purchases by the user. The fulfillment of the online process may be completely managed by the fulfilling pharmacy. Preferably the marketing and product distribution of the discount card is managed by the operator of the discount program, which might be an insurance agency. The method of the present invention may offer discounts on any medication that have been negotiated in combination with traditional health insurance, in the event the insurance restricts or excludes the certain medication. Use of the present invention may be a voluntary benefit to any self-insured or self-funded group for a direct purchase by the group or by the groups employee. The discount card may be given away free by a pharmaceutical drug company, a pharmacy, an insurance company, a fertility clinic, or a doctor's office, which would mean the program would be free to the customer. When not purchased by the customer, the gift card may be given to the customer, or not.

A purchased discount card using the discount program of the present invention preferably is directed to providing a discount on fertility drugs, but a discount card and program could be offered having nothing to do with a pharmacy or fertility drugs.

These, as well as other components, steps, features, objects, benefits, and advantages, will now become clear from a review of the following detailed description of illustrative embodiments, the accompanying drawings, and the claims.

### BRIEF DESCRIPTION OF THE DRAWINGS

The drawings are of illustrative embodiments. They do not illustrate all embodiments. Other embodiments may be used in addition or instead. Details which may be apparent or unnecessary may be omitted to save space or for more effective illustration. Some embodiments may be practiced with additional components or steps and/or without all of the components or steps which are illustrated. When the same numeral appears in different drawings, it refers to the same or like components or steps.

FIG. 1 is a block diagram of one embodiment for the method of managing a computer-based discount program and providing discounts for goods/services.

FIG. 2 is a front view of one embodiment of a discount card for the method of managing a computer-based discount program and providing discounts for goods/services.

FIG. 3 is a back view of one embodiment of a discount card for the method of managing a computer-based discount program and providing discounts for goods/services.

FIG. 4 is a front view of one embodiment of an advertisement for the method of managing a computer-based discount program and providing discounts for goods/services.

FIG. 5 is a back view of one embodiment of an advertisement for the method of managing a computer-based discount program and providing discounts for goods/services.

### DETAILED DESCRIPTION OF THE DRAWINGS

In the following detailed description of various embodiments of the invention, numerous specific details are set forth in order to provide a thorough understanding of various aspects of one or more embodiments of the invention. However, one or more embodiments of the invention may be practiced without some or all of these specific details. In other instances, well-known methods, procedures, and/or components have not been described in detail so as not to unnecessarily obscure aspects of embodiments of the invention.

While multiple embodiments are disclosed, still other embodiments of the present invention will become apparent to those skilled in the art from the following detailed description, which shows and describes illustrative embodiments of the invention. As will be realized, the invention is capable of modifications in various obvious aspects, all without departing from the spirit and scope of the present invention. Accordingly, the screen shot figures, and the detailed descriptions thereof, are to be regarded as illustrative in nature and not restrictive. Also, the reference or non-reference to a particular embodiment of the invention shall not be interpreted to limit the scope of the invention.

In the following description, certain terminology is used to describe certain features of one or more embodiments of the invention. For instance, “discount card” refers to any card that provides discounts for current purchases of fertility-based pharmaceutical products and may be in the form of, without limitation, PEG cards, gift cards, phone cards, credit cards, pharmacy cards, and coupon cards. The term “third party” refers any entity other than the patient, and may include, without limitation, insurance companies, pharmacies, pharmaceutical drug companies, retail stores, administration companies, or government agencies.

The present invention is a cash-based or direct pay program, system, and method that provides patients discounts for fertility related pharmaceutical products and services. The discounts are provided by a discount card, which may be purchased by the patient through a doctor, pharmacy, retail store, or online. Once the discount card is purchased and activated, the patient may use the card to make purchases at any pharmacy or retail store to receive certain discounts. The term “goods/services” refers to the combination of goods and services that might be provided by an entity in any industry. “Goods/services” expressly includes fertility medications and fertility treatments and services. The providers of the “goods/services” typically charge for the goods and services.

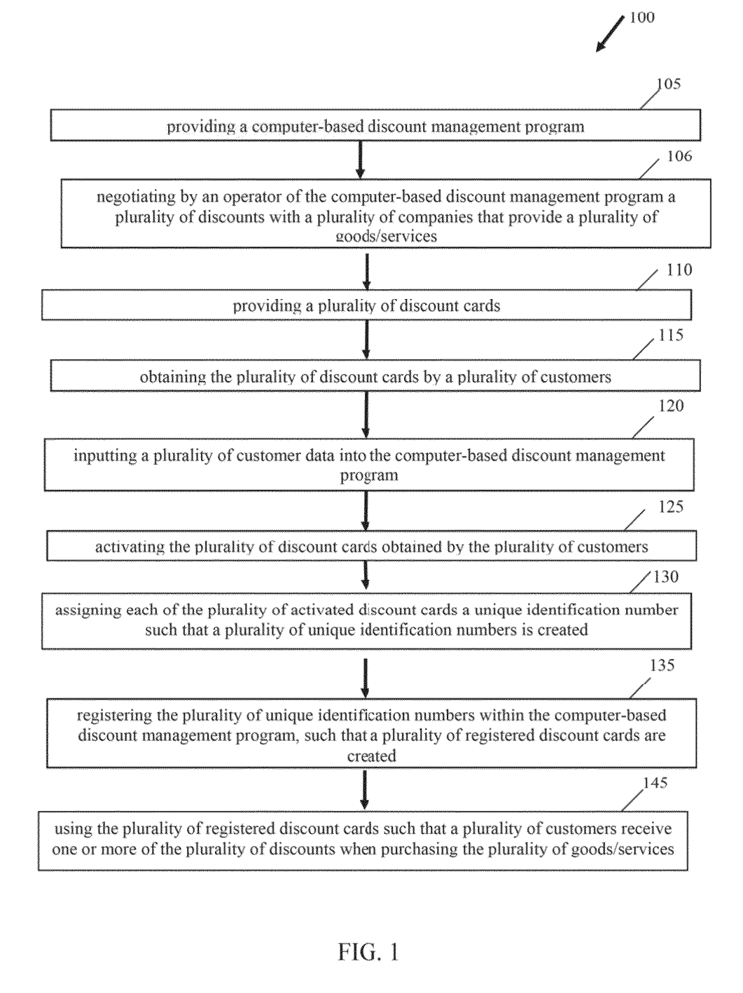

FIG. 1 is a block diagram of one embodiment for the method of managing a computer-based discount program and providing discounts for goods/services. As shown in FIG. 1, the method 100 preferably comprises the steps of: providing a computer-based discount management program 105; negotiating by an operator of the computer-based discount management program a plurality of discounts with a plurality of companies that provide a plurality of goods/services 106; providing a plurality of discount cards 110; obtaining the plurality of discount cards by a plurality of customers 115; inputting a plurality of customer data into the computer-based discount management programs 120; activating the plurality of discount cards obtained by the plurality of customers 125; assigning each of the plurality of activated discount cards a unique identification number such that a plurality of unique identification numbers is created 130; registering the plurality of unique identification numbers within the computer-based discount management program, such that a plurality of registered discount cards are created 135; and using the plurality of registered discount cards such that a plurality of customers receive one or more of the plurality of discounts when purchasing the plurality of goods/services 145. The method 100 may also include other steps without deviating from the scope of the invention.

The first step of the method 100 is providing a computer-based discount management program 105. The computer-based discount management program is preferably a software program or application designed to manage one or more discounts for pharmaceutical goods/services, especially fertility-based products. The discount management program is typically accessed through multiple computers through the Internet, and stores information of all the participants involved. The discount management program also preferably stores information relating to the discount services offered. Such information may include, without limitation, discounts on the types of goods/services involved with the program, information of the customers who participate with the discount program, and information of doctors, fertility centers, pharmaceutical companies, pharmacies, retail stores, fertility clinics, and administrators who participate with the discounted offerings. The discount management program also provides the ability to allow anyone such as customers, doctors, fertility centers, pharmaceutical companies, and pharmacies to input information into the discount management program's database.

FIG. 1 shows the second step of the method 100—negotiating by an operator of the computer-based discount management program a plurality of discounts with a plurality of companies that provide a plurality of goods/services 106. The negotiation step typically requires the involvement of both the operator of the discount program and participating pharmacies or pharmaceutical companies selling the fertility medication. The negotiation step also typically requires the operator to talk to one or more people or parties, intending to bargain and reach an agreement upon certain discounts. These negotiations may occur in a business setting and typically results with one or more discounts for certain fertility medications and prescribed medications.

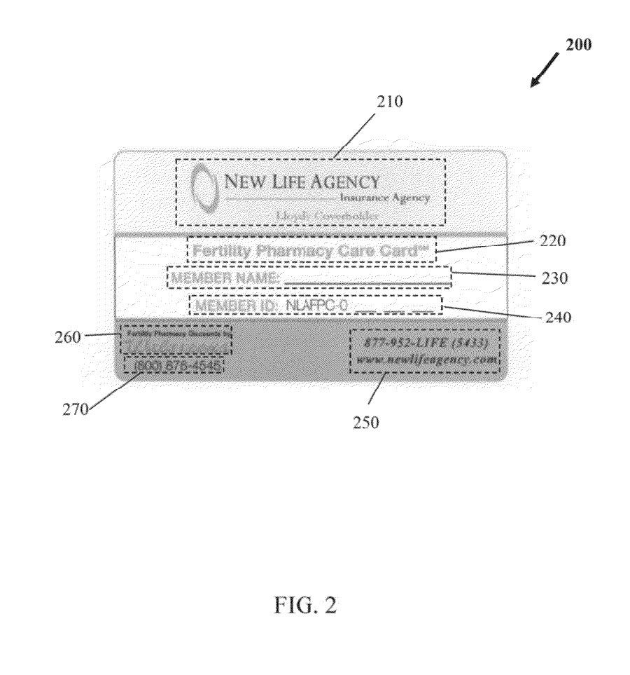

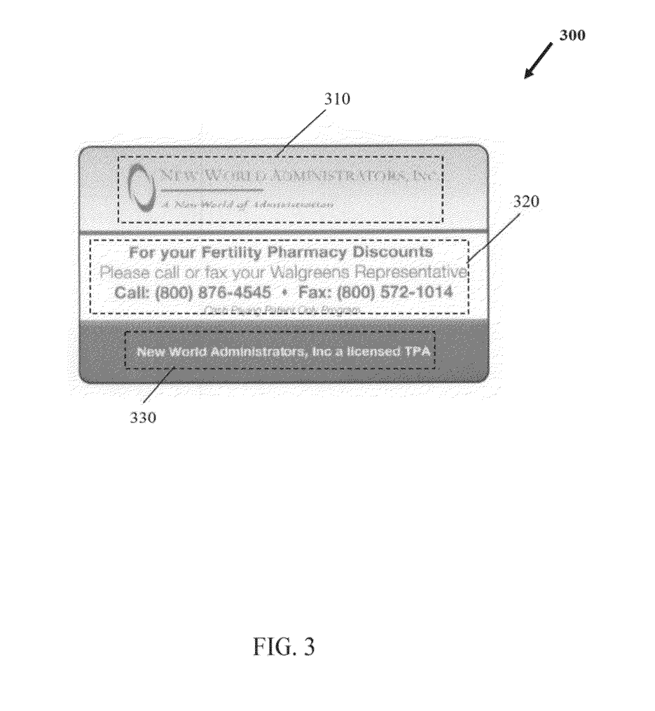

FIG. 1 also shows the third step of the method 100—namely, providing a plurality of discount cards 110. The discount card 200 (a front view and back view of the discount card are shown in FIGS. 2 and 3, respectively), is preferably provided by an obstetrician, gynecologist, fertility center, and/or pharmaceutical company, but may also be provided by a pharmacy, or retail store. The discount card 200 is preferably made of paper material, plastic/laminated plastic material, or the like.

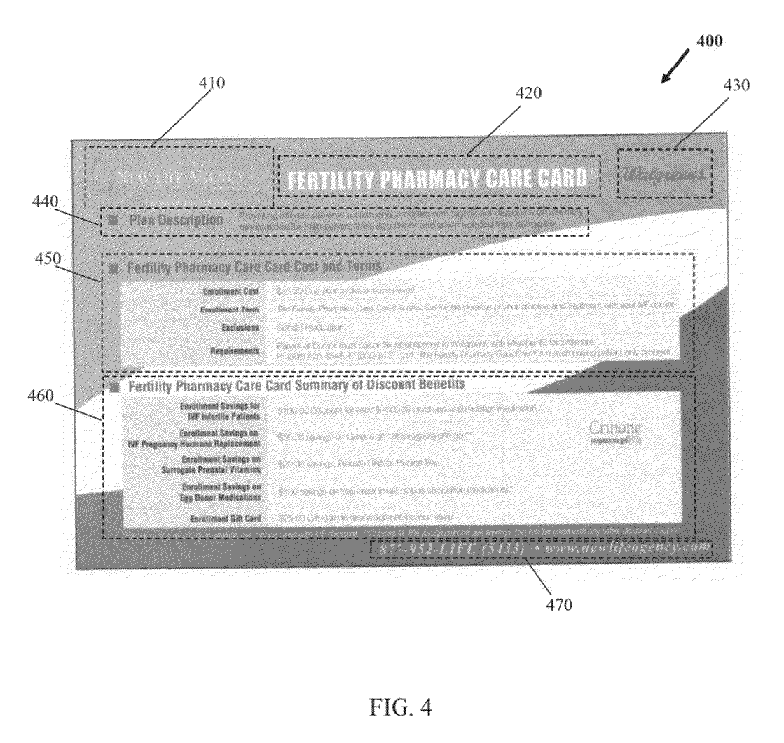

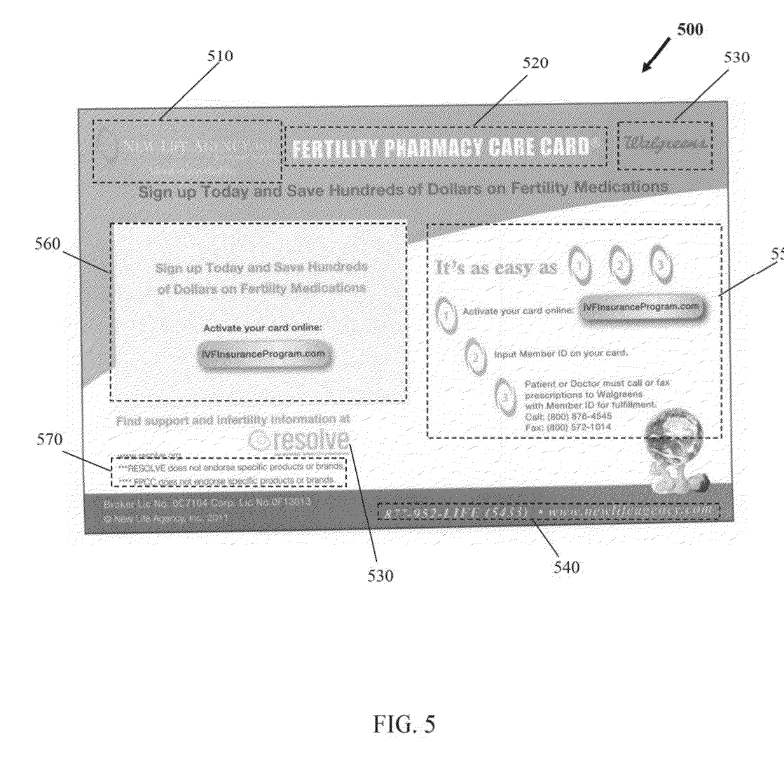

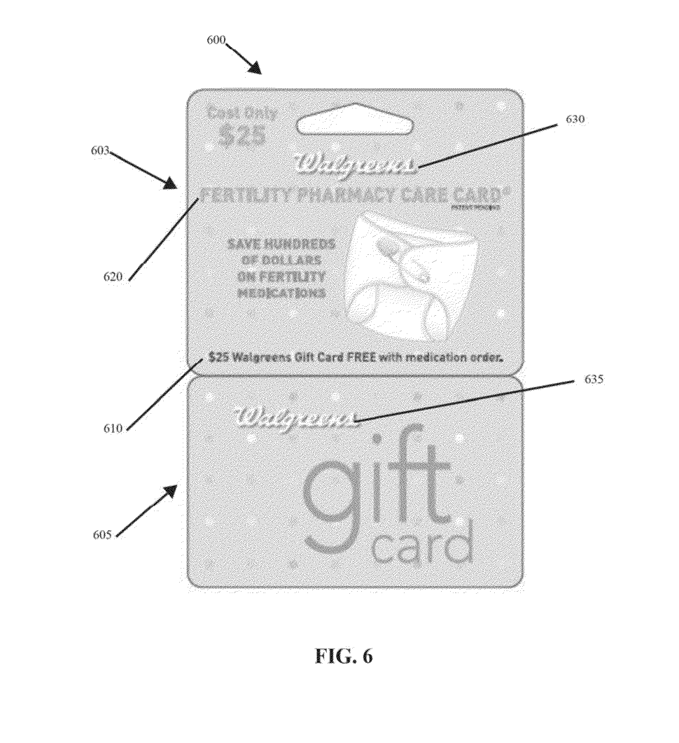

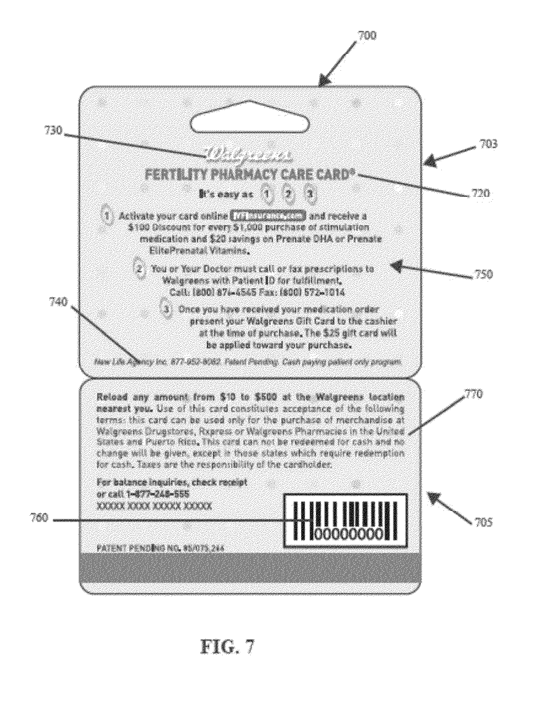

Preferably, the discount card 200 is provided along with an advertisement 400 (a front view and back view of one embodiment of the advertisements are shown in FIGS. 4 and 5, respectively), which includes other various print marketing information. Like the discount card 200, the advertisement 400 is also preferably made of paper material, plastic/laminated plastic material, or the like.

FIG. 1 shows the next step of the method 100—obtaining the plurality of discount cards by a plurality of customers 115, which preferably involves customers purchasing the discount cards with cash. It should be understood that the present invention also allows customers to purchase the discount card with cash by using a bank account such as a debit account or checking account through checks or online purchases. When customers purchase the discount card, a gift card, in the amount paid for the card, is typically given to the customer to redeem at the location where the discount card was purchase. Additionally, customers, when using or receiving the card, usually interact with a third party, which may be a doctor such as an obstetrician or gynecologist, fertility center, pharmaceutical company, pharmacy, retail store, fertility clinic, or administrator of the discount program. The discount card 200, which generally includes the advertisement 400, may also be included in addition to any packaging of a retail product such fertility medications and prescription medications. Alternatively, the discount card may be given away by any of the third parties that might have sold it to the customer.

FIG. 1 also shows the next four steps of the method 100—inputting a plurality of customer data into the computer-based discount management programs 120; activating the plurality of discount cards obtained by the plurality of customers 125; assigning each of the plurality of activated discount cards a unique identification number such that a plurality of unique identification numbers is created 130; and registering the plurality of unique identification numbers within the computer-based discount management program, such that a plurality of registered discount cards are created 135. Generally, after customers purchase the discount card 200, customer data is inputted into the computer-based discount management program. Such customer data information includes, without limitation, the customers' name, address, contact information such as telephone number or email address, date of birth, unique identification number, doctor(s), and insurance information (if applicable), but may also include other information such as recent transactions, and common prescribed medications. When the customer data information is inputted into the computer-based management program, the discount management program preferably generates multiple unique identification numbers that are assigned to the discount cards 200. Each of the discount cards 200 is then activated by the customer, doctor, fertility center, pharmaceutical company, pharmacy, retail store, fertility clinic, or administrator of the discount program. The activation may also be performed in-person with the doctor, fertility center, retail store, or pharmacy, and/or may also be performed online, through a telephone call, fax, or physical letter. Once the discount card 200 is activated, a unique identification number 240 is created and assigned to the discount card 200, whereupon the unique identification number 240 associates the customer with the discount card 200. The unique identification number 240 preferably includes alphanumeric numbers, but may also include other. American Standard Code for Information Interchange (ASCII) characters such exclamation points, hyphens, percentage signs, ampersands, asterisks, and the like. After assigning the discount card 200 with a unique identification number 240, the unique identification number 240 is typically registered within the computer-based discount management program, and may be performed by inputting information online, by fax, or through a telephone call. The computer-based online system is preferably part of the discount management program and preferably includes a database, which stores unique identification numbers, identities of different customers, customers' address, contact information, insurance information (if applicable), and common prescribed medications. An acknowledgment may also be sent to the patient, which confirms the inputting, activating, assigning, and registering of the discount card 200, and is preferably performed by email or an online system, but may be sent by any type of messages such as a physical letter, fax, text message, or a telephone call.

FIG. 1 also shows the final step of the method 100—using the plurality of registered discount cards such that a plurality of customers receive one or more of the plurality of discounts when purchasing the plurality of goods/services 145. With the discount card 200, customers generally may purchase one or more goods/services, preferably fertility-medications and prescription medications, with discounted offerings. The discounted offerings may include, without limitation, prescribed drugs, medications, fertility products such as fertility kits, medical services, and any other fertility-related item/service. Additionally, the discounted goods/services are purchased by the customers without insurance.

FIG. 2 is a front view of one embodiment of a discount card for the method of managing a computer-based discount program and providing discounts for goods/services. As shown in FIG. 2, the front of the discount card 200 preferably includes: a logo 210; title of discount card 220; the customer's name 230; an identification number 240; contact information 250; one or more brands 260; and contact information for the one or more brands 270. The logo 210 of the discount card 200 preferably is the image, name, or trademark of the company of the computer-based discount management program and typically includes the name of that company. Preferably, the title of the discount card 220 is the title of the computer-based discount management program. Preferably, the customer's name 230 is the name of the person who is participating and receiving the benefits of the discount and may include the customer's initials or printed signature. The identification number 240, as mentioned above, is preferably a sequence of alphanumeric characters that identify the customer associated with the discount card 200. Preferably, the contact information 250 includes one or more telephone contact numbers such as a business number, fax number, cell phone number, but may also include website addresses, email addresses and mailing addresses. The one or more brands 260 are typically similar to the logo 210 and include trademarks, logos, and any type of branding, which identifies third party participants, retailers, and sponsors, of the discount management program. The contact information of the one or more brands 270 typically identifies contact information of the third party participants of the method 100, and generally includes information such business addresses, phone numbers, email addresses, website addresses, business numbers, fax numbers, and the like.

FIG. 3 is a back view of one embodiment of a discount card for the method of managing a computer-based discount program and providing discounts for goods/services. As shown in FIG. 3, the back of the discount card 300 preferably includes: a logo 310; contact information 320; and a name of any third party administrator 320. The logo 310 of the discount card 200, as mentioned above, is preferably the image, name, or trademark of the company that administrates the discount program. The contact information 320 preferably includes, without limitation, a telephone contact number such as a business number, fax number, cell phone number, and may also include other contact information such as website addresses, email addresses, and mailing addresses. Preferably, the name of a third party administrator 320 is the name of the company that administers services for employer groups and insurance agencies, and may be the same company listed on logo 310.

FIG. 4 is a front view of one embodiment of an advertisement for the method of managing a computer-based discount program and providing discounts for goods/services. As shown in FIG. 4, the front view of the advertisement 400 preferably includes: a logo 410; title of the advertisement 420; one or more brands 430; description of the discount plan 440; cost and terms of the discount card 450; summary of discounts and benefits 460; and contact information 470. Preferably, the logo 410 of the advertisement 400 includes the image, name, or trademark of the company who provides the benefits of the discount card 200 and typically includes the name of the company. The title of the advertisement 420 preferably is the title of the discount management program, which may be a trademark, but may also be the title of discount card 200. Preferably, the one or more brands 430 include trademarks, logos, and any type of branding that identifies entities, providers, or third party participants of the discount management program. The description of the discount plan 440 generally describes the discount program and preferably includes a brief explanation of the discounts; the type of patients who are eligible for the discounts; and type of products and services, in which the discounts may be applied to. The description of the discount plan 440 may also include other information without deviating from the scope of the invention. The cost and terms of the discount card 200 typically includes information regarding costs of enrollment, terms of enrollment, types of discount exclusion, and requirements to purchase the prescribed products and services. However, it should be understood that the present invention allows information relating to the cost and terms of the discount card 200 to also include other information without deviating from the scope of the invention. The summary of discounts and benefits 460 preferably includes information relating to enrollment gift card and savings information, but may also describe the type of patients eligible for such savings. As shown in FIG. 4, the summary of discounts and benefits 460 may include, without limitation, enrollment savings for IVF infertile patients, enrollment savings on IVF pregnancy hormone replacement, enrollment savings on surrogate prenatal vitamins, and enrollment savings on egg donor medications, but may also include other information without deviating from the scope of the invention. Contact information 470, as mentioned above, preferably includes one or more telephone contact numbers such as a business number, fax number, cell phone number, and may also include website addresses, email addresses and mailing addresses without deviating from the scope of the invention.

FIG. 5 is a back view of one embodiment of an advertisement for the method of managing a computer-based discount program and providing discounts for goods/services. As shown in FIG. 5, the back view of the advertisement document 500 preferably includes: a logo 510; a title of the advertisement document 520; one or more brands 530; contact information 540; directions of using the discount management program 550; sign-up directions 560; and one or more disclaimers 570. Preferably, the logo 510 of the back of the advertisement 500, as mentioned above, includes the image, name, or trademark of the company who provides the benefits of the discount card 200 and typically includes the name of the company. The title of advertisement document 520 preferably is the name of the discount management program, and may include other information as well. Preferably, the one or more brands 530 include trademarks, logos, and any type of branding, which identifies third party participants, providers, and entities, of the discount management program. Preferably, the directions of using the discount program 550 provide information on how to activate the discount card 200. As shown in FIG. 5, directions of using the discount management program may include the steps of: logging onto a website, inputting an identification number, and sending of the patient's prescription information to a pharmacy or retail store. However, the present invention may include other information or steps such as activating the discount card 200 in-person, by telephone/fax, by email, and the like without deviating from the scope of the invention. The contact information 540 typically includes one or more contact information such business addresses, phone numbers, email addresses, website addresses, business numbers, fax numbers, and the like. The one or more disclaimers 570, which are typically originate from third parties, generally provide information as to the limitations of such advertisements.

Unless otherwise stated, all measurements, values, ratings, positions, magnitudes, sizes, locations, and other specifications which are set forth in this specification, including in the claims which follow, are approximate, not exact. They are intended to have a reasonable range which is consistent with the functions to which they relate and with what is customary in the art to which they pertain.

The foregoing description of the preferred embodiment of the invention has been presented for the purposes of illustration and description. While multiple embodiments are disclosed, still other embodiments of the present invention will become apparent to those skilled in the art from the above detailed description, which shows and describes illustrative embodiments of the invention. As will be realized, the invention is capable of modifications in various obvious aspects, all without departing from the spirit and scope of the present invention. Accordingly, the detailed description is to be regarded as illustrative in nature and not restrictive. Also, although not explicitly recited, one or more embodiments of the invention may be practiced in combination or conjunction with one another. Furthermore, the reference or non-reference to a particular embodiment of the invention shall not be interpreted to limit the scope the invention. It is intended that the scope of the invention not be limited by this detailed description, but by the claims and the equivalents to the claims that are appended hereto.

Except as stated immediately above, nothing which has been stated or illustrated is intended or should be interpreted to cause a dedication of any component, step, feature, object, benefit, advantage, or equivalent to the public, regardless of whether it is or is not recited in the claims.

What is claimed is:

1. A method of managing a computer-based discount program and providing discounts for goods/services, the steps comprising:
providing a computer-based discount management program;
providing a plurality of discount cards;
obtaining said plurality of discount cards by a plurality of customers;
activating said plurality of discount cards obtained by said plurality of customers;
assigning each of said plurality of activated discount cards a unique identification number such that a plurality of unique identification numbers is created;
registering said plurality of unique identification numbers within said computer-based discount management program, such that a plurality of registered discount cards are created;
wherein said plurality of registered discount cards provide a plurality of discounts for a plurality of goods/services, such that a plurality of discounted goods/services are available; and
using said plurality of registered discount cards such that said plurality of customers receive one or more of said plurality of discounts when purchasing said plurality of discounted goods/services.

2. The method of managing a computer-based discount program and providing discounts for goods/services of claim 1, further comprising the steps of:
inputting a plurality of customer data into said computer-based discount management program;
wherein when said plurality of customer data is inputted into said computer-based discount management program, said computer-based discount management program automatically generates said plurality of unique identification numbers that are assigned to said plurality of discount cards.

3. The method of managing a computer-based discount program and providing discounts for goods/services of claim 1, wherein said plurality of discount cards display one or more brands of a plurality of companies that provide said plurality of goods/services.

4. The method of managing a computer-based discount program and providing discounts for goods/services of claim 1, wherein said plurality of discounted goods/services are comprised of a plurality of fertility medications.

5. The method of managing a computer-based discount program and providing discounts for goods/services of claim 4, wherein said plurality of fertility medications are comprised of a plurality of prescription medications.

6. The method of managing a computer-based discount program and providing discounts for goods/services of claim 1, wherein said plurality of discounted goods/services are purchased by said plurality of customers directly without an insurance.

7. The method of managing a computer-based discount program and providing discounts for goods/services of claim 1, wherein at least one of said plurality of discount cards are purchased directly by at least one of said plurality of customers.

8. The method of managing a computer-based discount program and providing discounts for goods/services of claim 7, wherein a cost of said at least one of said plurality of discount cards purchased directly by said at least one of said plurality of customers is refunded via a gift card.

9. The method of managing a computer-based discount program and providing discounts for goods/services of claim 1, wherein at least one of said plurality of discount cards are purchased directly by the group consisting of: a obstetrician; a gynecologist; a fertility center; a pharmacy; a pharmaceutical company; a physician; a retail store; a self insured group; and an insurer.

10. The method of managing a computer-based discount program and providing discounts for goods/services of claim 1, further comprising the step of:
negotiating by an operator of said computer-based discount management program said plurality of discounts with a plurality of companies that provide said plurality of goods/services.

11. The method of managing a computer-based discount program and providing discounts for goods/services of claim 1, wherein at least one of said plurality of discount cards are provided as part of an advertisement.

12. A method of managing a computer-based discount program and providing discounts for goods/services, the steps comprising:
providing a computer-based discount management program;
providing a plurality of discount cards;
obtaining said plurality of discount cards by a plurality of customers;
inputting a plurality of customer data into said computer-based discount management program;
wherein when said plurality of customer data is inputted into said computer-based discount management program, said computer-based discount management program automatically generates a plurality of identification numbers that are assigned to said plurality of discount cards;
activating said plurality of discount cards obtained by said plurality of customers;
negotiating by an operator of said computer-based discount management program a plurality of discounts with a plurality of companies that provide a plurality of goods/services.
wherein said plurality of discount cards provide said plurality of discounts for said plurality of goods/services, such that a plurality of discounted goods/services are available; and
using said plurality of activated discount cards such that a plurality of customers receive one or more of said plurality of discounts when purchasing said plurality of goods/services.

13. The method of managing a computer-based discount program and providing discounts for goods/services of claim 12, wherein said plurality of discounted goods/services are comprised of a plurality of fertility medications.

14. The method of managing a computer-based discount program and providing discounts for goods/services of claim 13, wherein said plurality of fertility medications are comprised of a plurality of prescription medications.

15. The method of managing a computer-based discount program and providing discounts for goods/services of claim 14, wherein said plurality of discounted goods/services are purchased by said plurality of customers directly without an adequate insurance.

16. The method of managing a computer-based discount program and providing discounts for goods/services of claim 15, wherein at least one of said plurality of discount cards are purchased directly by at least one of said plurality of customers.

17. The method of managing a computer-based discount program and providing discounts for goods/services of claim 16, wherein a cost of said at least one of said plurality of discount cards purchased directly by said at least one of said plurality of customers is refunded via a gift card.

18. The method of managing a computer-based discount program and providing discounts for goods/services of claim 17, wherein said plurality of discount cards display one or more brands of said plurality of companies that provide said plurality of goods/services.

19. The method of managing a computer-based discount program and providing discounts for goods/services of claim 18, wherein said at least one of said plurality of discount cards are provided as part of an advertisement.

20. A method of managing a computer-based discount program and providing discounts for goods/services, the steps comprising:
providing a computer-based discount management program;
providing a plurality of discount cards;
obtaining said plurality of discount cards by a plurality of customers;
inputting a plurality of customer data into said computer-based discount management program;
wherein when said plurality of customer data is inputted into said computer-based discount management program, said computer-based discount management program automatically generates a plurality of unique identification numbers that are assigned to said plurality of discount cards;
activating said plurality of discount cards obtained by said plurality of customers;
registering said plurality of unique identification numbers within said computer-based discount management program, such that a plurality of registered discount cards are created;
negotiating by an operator of said computer-based discount management program a plurality of discounts with a plurality of companies that provide a plurality of goods/services;
wherein said plurality of registered discount cards provide said plurality of discounts for said plurality of goods/services, such that a plurality of discounted goods/services are available;
using said plurality of registered discount cards such that a plurality of customers receive said plurality of discounts when purchasing said plurality of goods/services;
wherein said plurality of discount cards display one or more brands of said plurality of companies that provide said plurality of goods/services;
wherein said plurality of discounted goods/services are comprised of a plurality of prescription fertility medications;
wherein said plurality of discounted goods/services are purchased by said plurality of customers directly without an adequate insurance.
wherein at least one of said plurality of discount cards are purchased directly by at least one of said plurality of customers;
wherein a cost of said at least one of said plurality of discount cards purchased directly by said at least one of said plurality of customers is refunded via a gift card; and
wherein said at least one of said plurality of discount cards are provided as part of an advertisement.
